(19) United States
(12) Patent Application Publication
(10) Pub. No.: US 2003/0069785 A1
(43) Pub. Date: Apr. 10, 2003

(54) METHOD FOR PROVIDING DISCOUNT INCENTIVES TO POTENTIAL CUSTOMERS WHO WISH TO MAKE AN IMMEDIATE PURCHASE

(76) Inventor: KURT H LOHSE, HUNTINGTON, CA (US)

Correspondence Address: LEONARD TACHNER, A PROFESSIONAL LAW CORPORATION, 17961 SKY PARK CIRCLE, SUITE 38-E, IRVINE, CA, 926146364

(21) Appl. No.: 09/482,830

(22) Filed: Jan. 11, 2000

(51) Int. Cl. G06F 17/60

(52) U.S. Cl. 705/14

(57) ABSTRACT

A method for substantially instant electronic generation of volume discount coupons based on projected total dollar amounts consumers are planning to spend at a particular retailer or group of retailers within a specified time. The method produces an unspecified-product discount coupon representing a consumer's intention to purchase a minimum dollar amount of goods or services from a specific retailer or group of retailers within a limited period of time. In a preferred embodiment of the invention, the method comprises the steps of making available an electronic internet tool that permits consumers to negotiate a volume discount with selected retailers by matching various previously arranged retailer discount amounts and conditions with consumer discount requests; providing notification of the final match conditions to both the consumer and to the selected retailers; tracking and supplying historical and regional discount information to retailers regarding cost effective consumer incentive patterns; and creating and linking custom maps providing directions to the local retailers for whom coupons have been generated.

### BACKGROUND OF THE INVENTION

1. Field of the Invention

The present invention relates generally to the field of distribution of product nonspecific coupons over the internet. The invention relates more specifically to a method for rewarding potential, immediate customers with discount incentives to make purchases at a particular store or chain of stores within a limited period of time, the incentives taking the form of coupons downloaded over the internet and printed by the purchaser at his or her computer system.

2. Background Art

The internet downloading and computer printing of discount coupons is not unique. U.S. Pat. No. 5,907,830 to Engel et al discloses an electronic coupon distribution system in which product-specific coupons are downloaded over the internet and printed at a consumer's computer system for subsequent redemption when the identified product-specific coupon can normally be redeemed at any retail store selling the particular product. Such coupons are no more beneficial to the retailer than any other coupon such as those published in newspapers or distributed through mass mailings. While a retailer may benefit indirectly through some increase in consumer traffic, typically all competing retailers who offer the particular product will generally benefit to the same extent.

Of course there are methods that enable specific retailers to attract customers through other forms of incentives. For example, hard coupons are often distributed in mass coupon book mailings sometimes in conjunction with other non-competing retailers who share space in a mall or shopping center. Hard coupons that are retailer specific may also be distributed in daily publications such as by newspaper inserts and the like. Unfortunately, coupon book mailings and newspaper inserts can be very costly and a retailer can't expect more than a very small percentage of recipients to actually use the coupons. Thus, the return on the investment for such hard coupon distribution techniques can be meager at best and often the resulting business generated by such hard coupons does not justify the costs of distribution.

It would be highly advantageous if there were a system for distributing non-product specific coupons, or in other words, retailer-specific coupons, over the internet to potential customers who plan to make immediate or at least imminent use of such coupons at a particular retail store or retail chain. Distribution over the internet would reach consumers who have a very strong and immediate interest in taking advantage of an incentive to purchase products or services redeemable through such retailer-specific coupons.

### SUMMARY OF THE INVENTION

The present invention comprises a method for substantially instant electronic generation of volume discount coupons based on projected total dollar amounts consumers are planning to spend at a particular retailer or group of retailers within a specified time. The method produces an unspecified-product discount coupon representing a consumer's intention to purchase a minimum dollar amount of goods or services from a specific retailer or group of retailers within a limited period of time. In a preferred embodiment of the invention, the method comprises the steps of making available an electronic internet tool that permits consumers to negotiate a volume discount with selected retailers by matching various previously arranged retailer discount amounts and conditions with consumer discount requests; providing notification of the final match conditions to both the consumer and to the selected retailers; tracking and supplying historical and regional discount information to retailers regarding cost effective consumer incentive patterns; and creating and linking custom maps providing directions to the local retailers for whom coupons have been generated.

The disclosed embodiment provides consumers with the ability to create their own discount coupons in return for preliminary purchasing information, and in turn, allows retailers to redirect marketing budgets slotted for untargeted mass marketing campaigns in order to subsidize the immediate volume discount and secure the sale. Because of the flexibilities offered by discount coupons based on total dollar amounts spent rather than product specific discounts, consumers will be encouraged to spend more and purchase a wider variety of items during each visit in order to get better discounts. Because of the information provided by the volume discount requests, retailers will have the ability to make their advertising and marketing budgets more efficient by using those funds to generate immediate sales, stimulate new sales in slow growth regions and create new avenues for one-to-one-consumer marketing relationships via the internet.

### OBJECTS OF THE INVENTION

It is therefore a principal object of the present invention to provide a method for instantly generating dollar volume discount coupons for consumers to use at specific retailers or retail chains within a specified period of time.

It is another object of the present invention to provide an internet website where consumers can obtain dollar volume discount coupons by matching their anticipated dollar volume of imminent spending at a particular retail store or retail store chain and the preselected dollar volume and time constraint conditions established by participating retail stores and retail store chains for issuing discount coupon incentives.

It is yet another object of the present invention to provide a consumer an electronically generated discount coupon for a particular retail store along with a map providing directions for locating that store.

It is still another object of the present invention to provide a method for substantially increasing the effectiveness of retailers' discount incentive programs by electronic generation of dollar volume discount coupons in response to potential customers' inquiries on the internet.

### BRIEF DESCRIPTION OF THE DRAWINGS

The aforementioned objects and advantages of the present invention, as well as additional objects and advantages thereof, will be more fully understood hereinafter as a result of a detailed description of a preferred embodiment when taken in conjunction with the following drawings in which:

FIG. 1 is an internet website page of the invention for registering retailer participants;

FIG. 2 is an internet website page of the invention for obtaining discounting conditions from retailers;

FIG. 3 is an internet website page of the invention for registering customers;

FIG. 4 is an internet website page of the invention for customers to log in;

FIG. 5 is an internet website page of the invention for customers to generate a discount coupon;

FIG. 6 is an internet website page of the invention presenting a selected discount coupon and map for printing; and

FIGS. 7-9 are flow charts of the invention illustrating the steps of the method hereof.

### DETAILED DESCRIPTION OF A PREFERRED EMBODIMENT

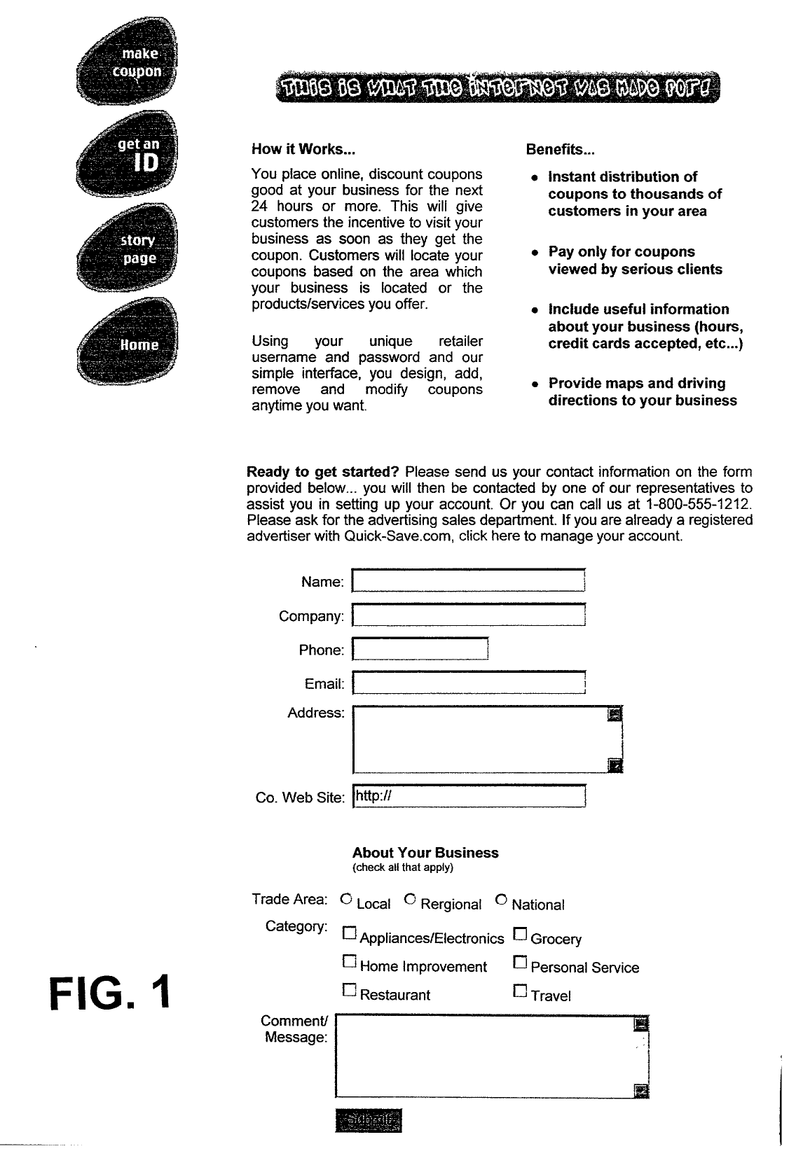

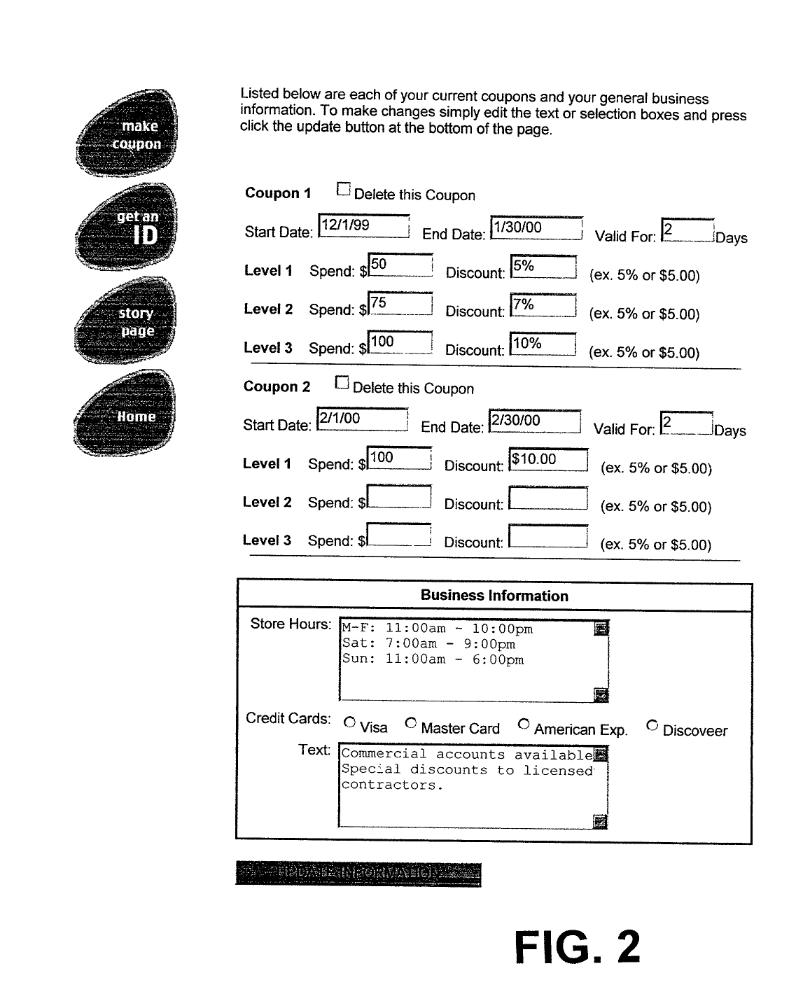

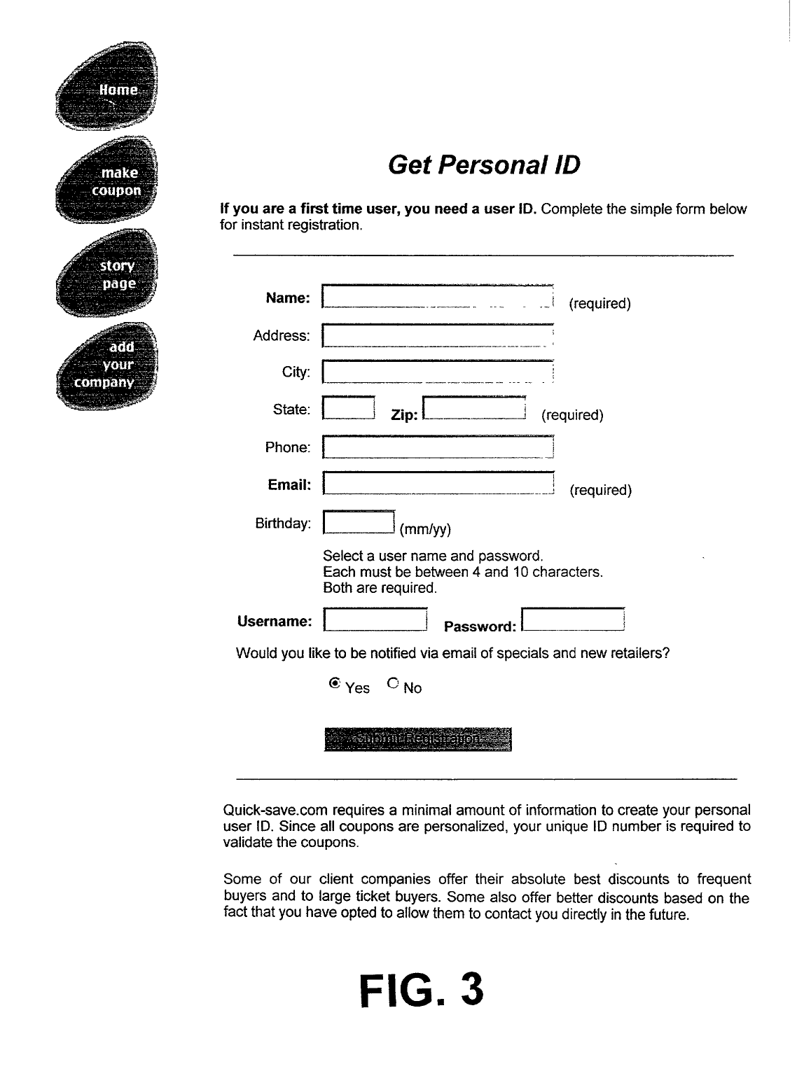

Referring now to the accompanying drawings and FIGS. 1-6 in particular, it will be seen that these figures depict website pages used in the present invention. More specifically, FIG. 1 depicts the website page used for registering retailers who wish to participate in the method hereof. It provides a vehicle for indicating the retailer's name and other identifying information including website address, category of business and trade area. FIG. 2 provides a vehicle for setting coupon parameters by registered retailers. The parameters include start and end dates, coupon use period (measured from date of issuance) and purchase amount versus discount in percentage or dollars. There is also provision for indicating additional information such as store hours, credit cards accepted and miscellaneous business-related messages. FIG. 3 provides a registration page for customers who wish to participate. It provides a vehicle for indicating the customer's name, address, E-mail address, birth date and establishes a user name and password that are unique to each customer.

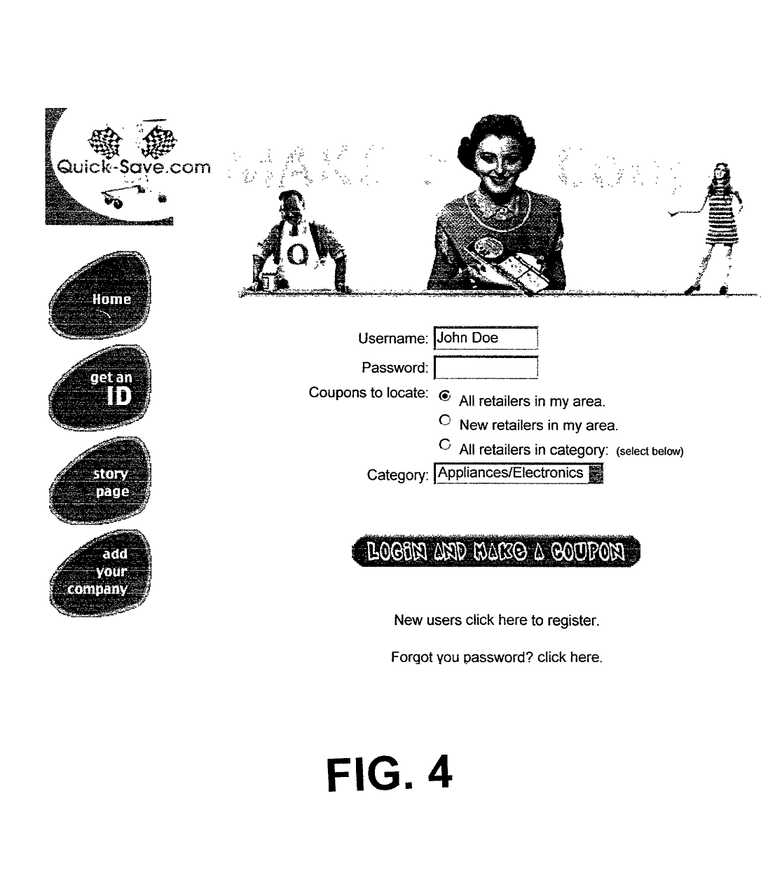

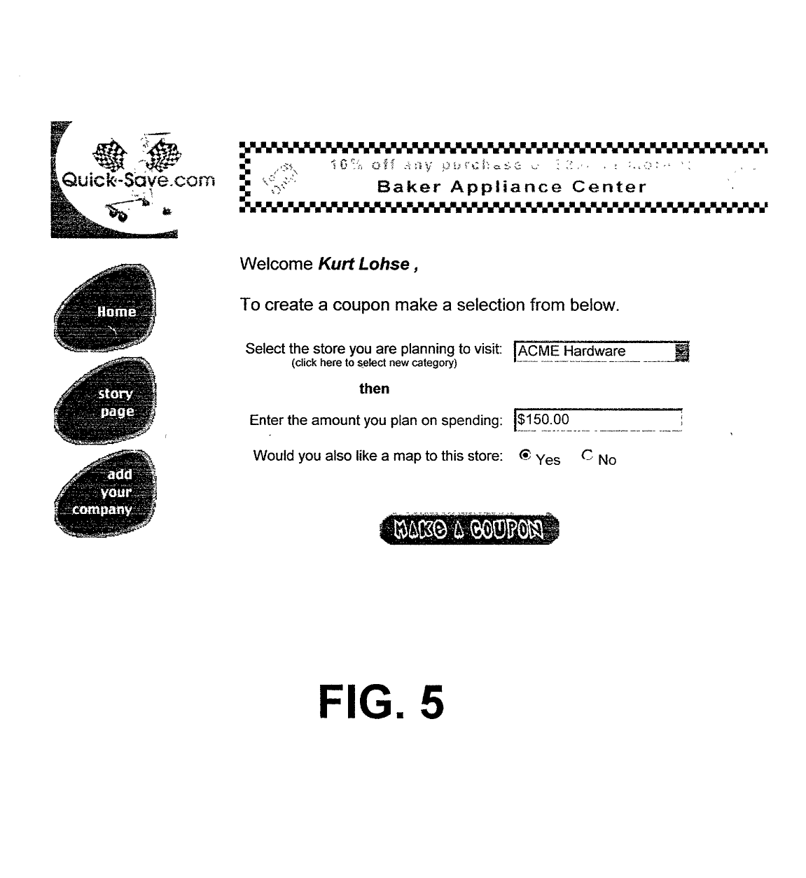

FIG. 4 is a website page used in the present invention to permit a customer to log in and select retailers by area, by recent addition or by product category. FIG. 5 is a website page which permits a customer to initiate a coupon generation process for a selected retailer. It provides entries for the name of the retailer or retail chain and the amount of the imminent purchases anticipated by the customer. It also gives the customer the option of generating a map of the retailer's location.

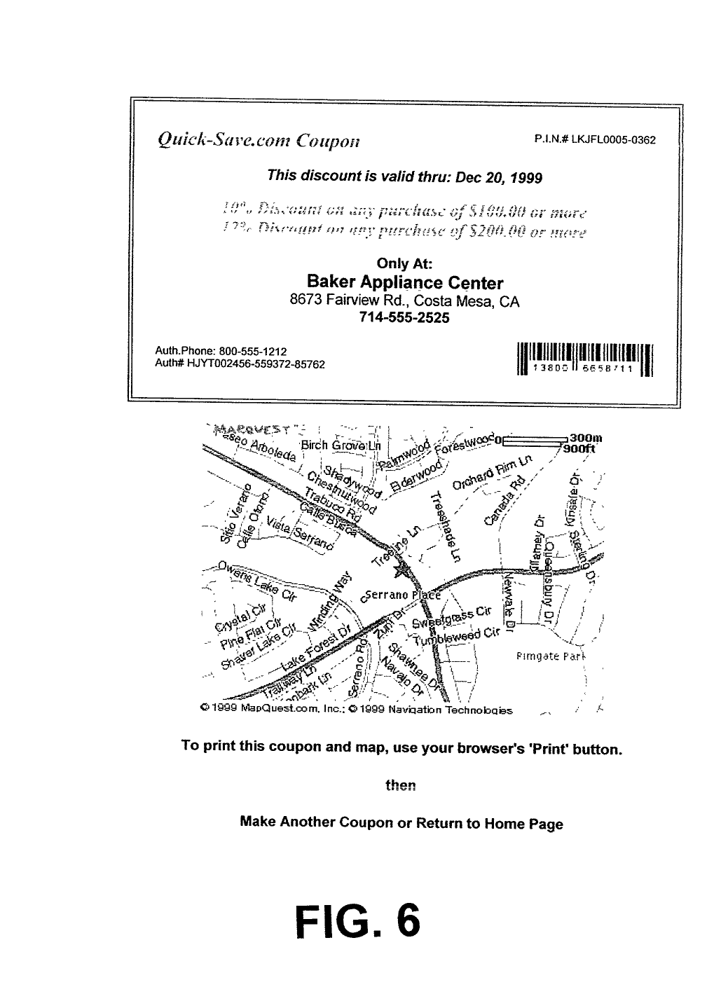

FIG. 6 illustrates a typical discount coupon generated in accordance with the method of the invention. As seen in FIG. 6, a typical coupon will have an expiration date and the amount of the discount for a given minimum purchase amount. It will, of course, also include identification of the retailer by name and address. Other information such as authorization phone number, code numbers and UPC bar code data may be provided. The bar code data may be used to ensure that the discount data is genuine and in accordance with retailer registration parameters. A map is also available to provide street directions to the retailer's location. The page depicted in FIG. 6 is intended to be printed by the customer so that it may be hand carried to the retailer to be redeemed for the indicated discount.

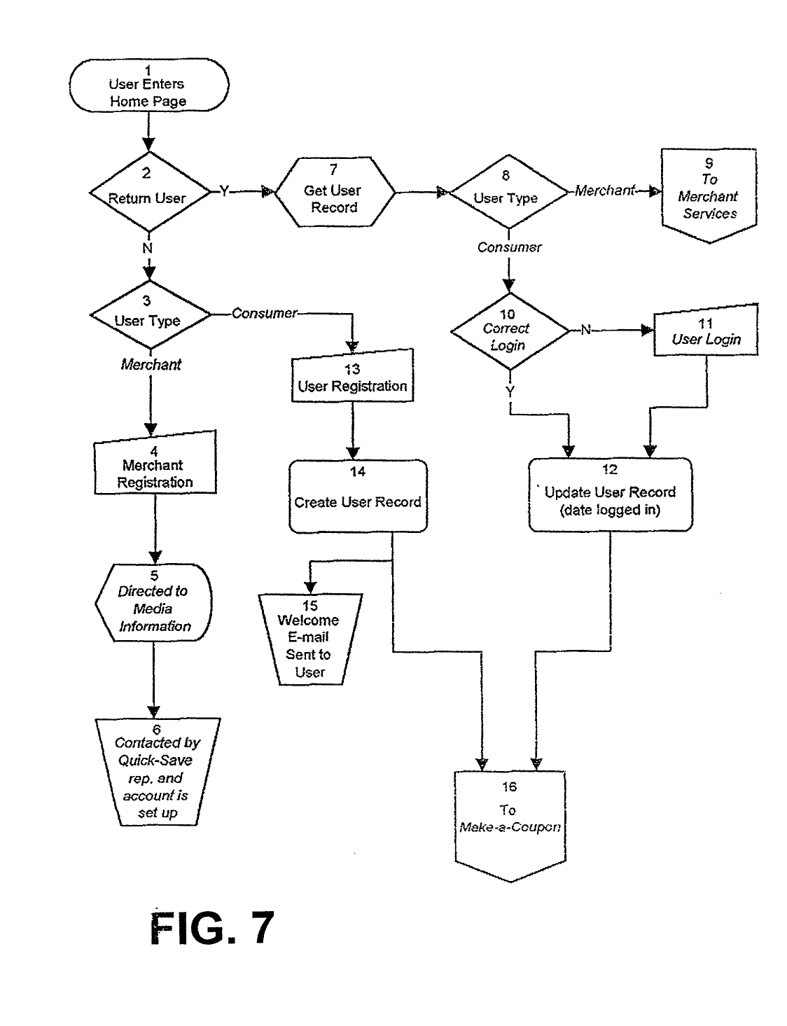

FIG. 7 is a flow chart illustrating home page entry by a user who may be either a customer or a retailer. The first step determines whether the user is a return user or a new user. If the user is already registered, his or her record is accessed and then it is determined whether the user is a consumer or a merchant (customer or retailer). If the user is a consumer and has logged in correctly, the login data is recorded and the user is given access to make a coupon. If the user is a merchant, access is given to merchant services which will be described in flow chart form below. If the user is not yet registered, it is first determined whether the user is a consumer or a merchant. If the unregistered user is a merchant, registration is first implemented and then the merchant is given access to relevant media information and then contacted by the website host to set up a merchant account. If the unregistered user is a consumer, registration is first implemented and a user record is created for the newly registered consumer. Welcome message E-mail may then be sent to the new consumer. The consumer is then given access to make a coupon as described below.

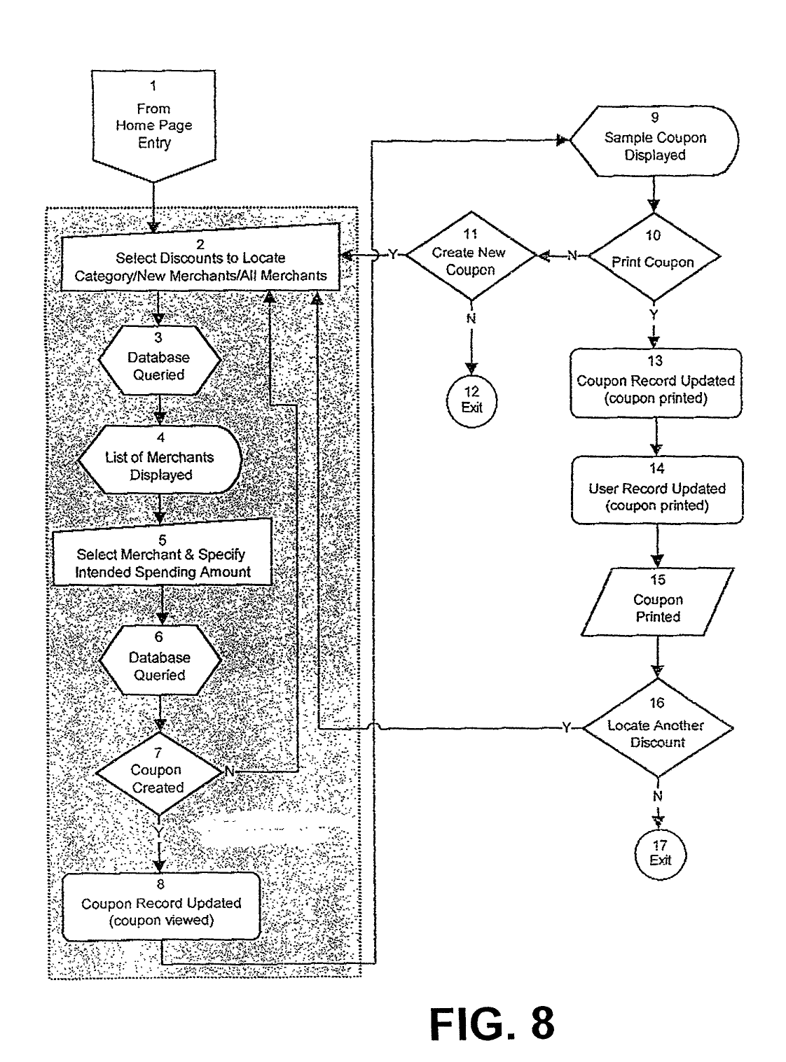

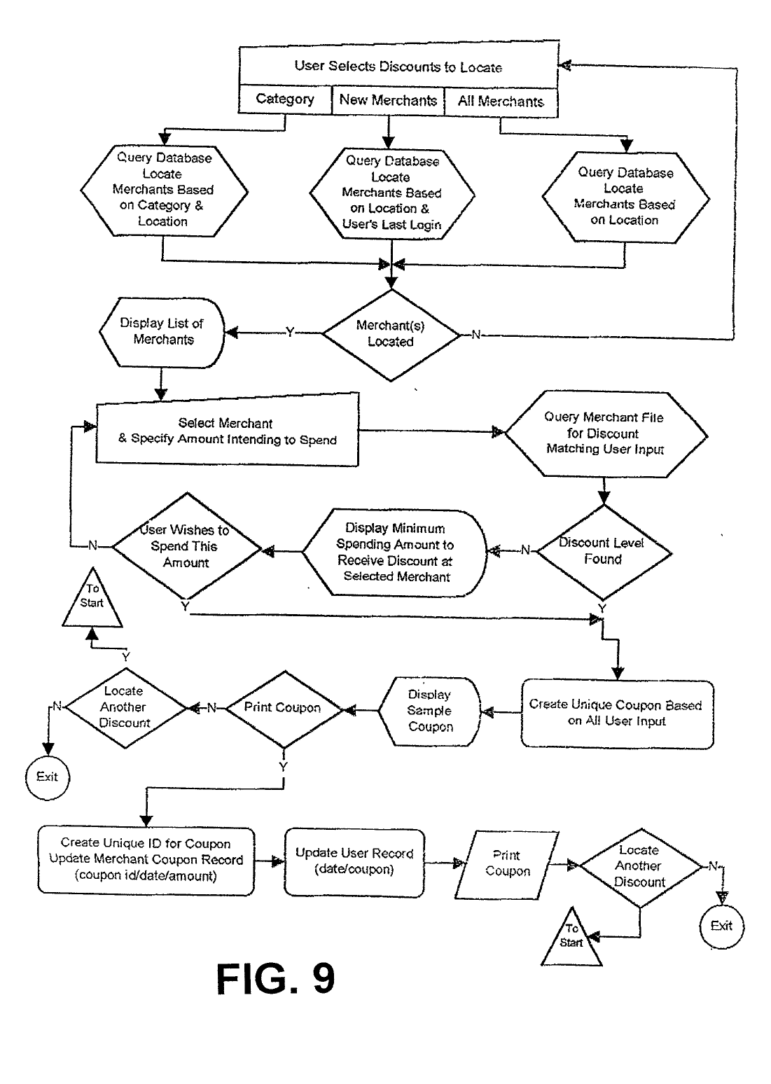

FIGS. 8 and 9 illustrate in flow chart form the details of making a coupon in accordance with the preferred embodiment of the invention. FIG. 9 is actually a more detailed flow chart of the outlined portion of FIG. 8. As seen in both FIGS. 8 and 9, the first step in make-a-coupon process is to have the user select discounts to be located in the consumer's area by category of products offered, newly registered merchants or all merchants in that area. As seen best in FIG. 9, this step is carried out by querying one of three different combinations of database criteria. If the desired merchants are found, a list of those merchants is displayed. If the desired merchants are not found, the search through the databases continues. The user eventually selects the desired merchant and specifies the amount he or she intends to spend on purchases at that merchant's store. The inventive method then queries the corresponding merchant file to find a discount parameter that may match the amount specified by the consumer. If no match is found, the merchant's minimum spending amount for a discount is displayed to permit the consumer the opportunity to raise his or her spending amount to the minimum specified. Eventually, when a discount level is found, a coupon for the selected merchant and having the matching parameters, is displayed and, if acceptable to the consumer may be printed on the consumer's computer printer. If the consumer does not wish to print the coupon, the entire process is repeated or the consumer may exit the site. If the coupon printing step is carried out, a unique identification number is printed as well. In addition, both the merchant's coupon record and the consumer's record are updated. After coupon printing the user may seek another discount or exit the site.

Having thus disclosed a preferred embodiment of the assembly and method of the invention, it being understood that many variations and additions are contemplated, what is claimed is:

1. A method for providing discount incentives to potential customers for making purchases from service or goods providers; the method comprising the steps of:
providing an internet website for providers to register and to set their respective discount parameters for issuing discount coupons to potential customers;
permitting access to said website by said potential customers to register and search for registered providers from whom they wish to make purchases;
establishing customer purchasing parameters for a selected provider and indicating a match between discount parameters and purchasing parameters; and
presenting a website display of a discount coupon corresponding to said matching parameters for printout by a registered customer for subsequent redemption at a provider's place of business.

2. The method recited in claim 1 wherein said matching parameters comprise an amount to be spent by the customer and a specified period of time in which said amount must be spent.

3. The method recited in claim 1 wherein said presenting step further comprises the steps of generating a map indicating the location of a selected provider and adding said map to said website display.

4. The method recited in claim 1 further comprising the step of establishing a data file of coupon generation for each said provider.

5. The method recited in claim 1 further comprising the step of including at least one verification number on each said discount coupon.

6. The method recited in claim 1 further comprising the step of displaying a search page at said website for permitting a postponed customer to search for a provider based upon selected criteria.

7. The method recited in claim 6 wherein said search criteria comprise at least one criterion taken from the group consisting of location, nature of products offered, nature of services offered and timing of provider registration at said website.

8. A method of issuing electronically-generated merchant-specific discount coupons to consumers over an internet communications link; the method comprising the steps of:
establishing an internet website on said link, said website having a selected address;
providing at least one website page for merchants to register and to set their respective discount parameters for said discount coupons;
providing at least one website page for consumers to register and search for registered merchants based upon selected search criteria;
providing at least one website page for consumers to indicate their desired purchase parameters;
comparing discount parameters of a merchant with purchase parameters of a consumer and indicating when a match of discount parameters and purchase parameters occurs;
presenting a website page having an electronic discount coupon representing the matching parameters for a particular merchant; and
permitting a consumer to print the presented page for subsequent redemption of the discount coupon represented at said presented website page.

9. The method recited in claim 8 wherein said matching parameters comprise an amount to be spent by the consumer and a specified period of time in which said amount must be spent.

10. The method recited in claim 8 wherein said presenting step further comprises the steps of generating a map indicating the location of a selected merchant and adding said map to said website display.

11. The method recited in claim 8 further comprising the step of establishing a data file of coupon generation for each said merchant.

12. The method recited in claim 8 further comprising the step of including at least one verification number on each said discount coupon.

13. The method recited in claim 8 further comprising the step of displaying a search page at said website for permitting a postponed consumer to search for a merchant based upon selected criteria.

14. The method recited in claim 13 wherein said search criteria comprise at least one criterion taken from the group consisting of location, nature of products offered, nature of services offered and timing of merchant registration at said website.
